(19) United States
(12) Patent Application Publication
(10) Pub. No.: US 2018/0203636 A1
(43) Pub. Date: Jul. 19, 2018

(54) LIKELIHOOD OF ACCESS BASED OBJECT STORAGE IN A CLOUD ENVIRONMENT

(71) Applicant: HEWLETT PACKARD ENTERPRISE DEVELOPMENT LP, Houston, TX (US)

(72) Inventors: Shilpa Pulipaka, Palo Alto, CA (US); Subhabrata Ghosh, Palo Alto, CA (US); Ashok Chandnani, Pontiac, MI (US)

(21) Appl. No.: 15/757,969

(22) PCT Filed: Oct. 30, 2015
(86) PCT No.: PCT/US2015/058461

§ 371 Date: Mar. 6, 2018

(51) Int. Cl. G06F 3/06; H04L 29/08

(52) U.S. Cl. CPC G06F 3/0638; G06F 3/0604; H04L 67/1097; G06F 3/0649

(57) ABSTRACT

Example implementations relate to object storage in a cloud storage environment. For example, an object may be received for storage in the cloud storage environment, and a likelihood of access may be determined for the object, based on a predicted access attribute of the object with respect to a time interval. A storage format may be selected for the object from a plurality of available storage formats of a single-tiered storage resource, for storing the object in the cloud storage environment. The storage format may be selected for individual objects of the collection based on an accessibility characteristic of the storage format and the likelihood of access of the object.

### BACKGROUND

Cloud based storage systems may be used unstructured content storage. This shift to cloud based architectures has caused a shift from file system based storage to object-based storage. Object stores deployed in the cloud can provide a layer of abstraction to users, where large amounts of content is addressable using standard HTTP based requests rather than file system calls, which may be operating system dependent.

### BRIEF DESCRIPTION OF THE DRAWINGS

FIG. 1 illustrates an example object management platform in which the described examples may be implemented.

FIG. 2A illustrates an example method for providing lifecycle data management, according to the present examples.

FIG. 2B illustrates another example method for providing lifecycle data management, according to the present examples.

FIG. 2C illustrates another example method for providing lifecycle data management, according to the present examples.

FIG. 2D illustrates another example method for providing lifecycle data management, according to the present examples.

FIG. 3 illustrates an example a computer system upon which embodiments described herein may be implemented.

### DETAILED DESCRIPTION

Examples such as described provide lifecycle data management in a cloud storage environment. According to an example, a computer system operates to receive an object to be stored in the cloud storage environment, and further to determine a likelihood of access for the object. Each object's likelihood of access is based on a predicted access attribute of the object with respect to a time interval. The computer system can select a storage format from a plurality of available storage formats of a single-tiered storage resource, for storing the object in the cloud storage environment. The storage format can be selected by the computer system based on an accessibility characteristic of the storage format and the likelihood of access of the object.

In other variations, examples are implemented using instructions that are stored with a non-transitory computer-readable storage medium that is executable by a processor to cause the processor to perform an example method as described.

Aspects described herein provide that methods, techniques and actions performed by a computing device are performed programmatically, or as a computer-implemented method. Programmatically means through the use of code, or computer-executable instructions. A programmatically performed step may or may not be automatic.

Examples described herein can be implemented using engines, which may be any combination of hardware and programming to implement the functionalities of the engines. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In such examples, the at least one machine-readable storage medium may store instructions that, when executed by the at least one processing resource, implement the engines. In examples, a system may include the machine-readable storage medium storing the instructions and the processing resource to execute the instructions, or the machine-readable storage medium may be separate but accessible to the system and the processing resource.

Furthermore, aspects described herein may be implemented through the use of instructions that are executable by a processor or combination of processors. These instructions may be carried on a non-transitory computer-readable medium. Computer systems shown or described with figures below provide examples of processing resources and computer-readable mediums on which instructions for implementing some aspects can be carried and/or executed. In particular, the numerous machines shown in some examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, aspects may be implemented in the form of computer programs.

Existing approaches for providing cloud based storage do not support efficient lifecycle management of content. For example, other approaches for data lifecycle management have taken the form of multi-tiered storage systems, such as hierarchical storage management (HSM) including multiple tiers of storage, such as solid state disks (SSDs), storage area networks (SANs), optical disks, and tape drives. Such systems often require expensive hardware and software. Additionally, systems provided under other approaches are not suited for use in cloud based architectures for reasons that include: (i) lack of configurability to, for example, deploy custom infrastructure in public cloud based environments; and (ii) use of application programming interfaces (APIs) which are hardware resource- and/or operating system-specific.

Additionally, some data lifecycle management systems control cost by deploying multiple tiers of storage, such that the most expensive storage is only used for the most relevant data, while less expensive storage, such as optical or tape drives, are used for less relevant data. Such an approach is not compatible with the cloud based storage environment, which is typically single-tiered. Further, while object stores provide lower cost storage, as the number of objects stored, and the size of objects stored continues to rise, even object stores are becoming increasingly expensive.

Examples described recognize the shortcomings of conventional approaches with respect to data lifecycle management in cloud based storage. Examples as described may provide storage-efficient, low cost, object lifecycle management in a single-tiered cloud based storage environment.

Examples as described provide for single-tiered object lifecycle management, suitable for deploying in a cloud based environment. Such cloud environments may be object stores (e.g., HP Helion Swift, Amazon Web Services, etc.) and may provide access to client application via a ReST (Representational State Transfer) interface. In particular, some examples provide for each data object (such as a document, photo, scanned image, audio or video file, etc.) to be assigned a “temperature,” indicating a degree of relevance. When an object has a “hot” temperature, it is expected to be of high relevance, and to have a high likelihood of access. Hot objects may involve a high degree of accessibility—for example, it may be expected that such objects will be frequently accessed, or that such objects may be temporally or otherwise highly relevant. When an object instead has a “warm” temperature, it is expected to be of medium relevance, and to have a medium likelihood of access. Finally, when an object has a “cold” temperature, it is expected to be of low relevance, and to have a low likelihood of access. Access to cold objects may not be critical for immediate usage. The temperature of an object may be used to provide lifecycle management for each object. While numerous examples are provided which describe values in terms of expressions of temperature (e.g., “hot” or “cold”), it should be appreciated that the examples generally attribute a classification or category that expresses a measure or expected likelihood that a document will be accessed in a given time period.

In some examples, temperatures may be based on a lifecycle expected for the type of object stored, and may be different for each type of object. Different types of objects may have different expected lifecycles because different types of objects may have differing levels of predicted access. An example storage platform may include lifecycle rules for each type of object, and apply these rules to objects uploaded to the platform. For example, an example storage platform may include an object lifecycle management engine to store and manage such rules. Some objects may be hot when they have recently been created. In one example, an object may be a mortgage application, which may be hot during the time when it is filed and approved, but become warm and then cold as it becomes less and less relevant (e.g., the application may become warm two months after approval, and cold after six months). Other types of objects may not be hot initially, but may become hot according to an expected time of access. For example, an object may be an invoice, having a due date, and the invoice may be cold when issued, but become warm and then hot as the due date approaches. Alternatively, an invoice may be warm when issued, and become hot as the due date approaches (e.g., the invoice may become hot one week before the due date). In a further example, an object may be an audit-related document, which may be hot during the audit, but warm or cold otherwise. Other objects may become hot according to a detected frequency of use, rather than according to object type. For example, if an object is accessed at a frequency greater than a threshold, it may become hot.

According to some examples, hot objects may be more accessible than warm objects, which may in turn be more accessible than cold objects. In some examples, an object may be stored differently depending on its temperature. In particular, a compressed copy of each object may be stored, regardless of an object's temperature, but in addition, an uncompressed copy may also be stored for objects which are hot. In some other examples, warm and cold objects may be stored as part of a Multiple-Merged-Compressed (MMC) file—multiple warm and cold objects may be combined and compressed to form such MMC files. The use of compression may increase the storage efficiency and decrease the cost of example object management platforms. In some examples, MMC creation may be based on parameters such as expected individual object size for an object type, and a target size for the combined and compressed MMC file. These parameters may be configured (e.g., in XML files) for each object type. The number of individual objects which may be contained in a single MMC file may be determined based on the type of objects to be contained in the MMC file, a required retrieval response time for objects in the MMC, a density of the objects in the MMC, and an amount of compression which may be attained.

Additionally, access to an object may be provided differently depending on the object's temperature. For example, access to hot and warm objects may be synchronous access, while access to cold objects may be asynchronous access. Because retrieval of cold objects has a low priority, asynchronous access may allow example object management platforms to respond to higher priority requests first. In some cases, the asynchronous access to cold objects may take multiple hours, or even multiple days. Asynchronous access may be advantageous for low-priority objects because object retrieval may be processed during off-peak hours, which may be less expensive, and may allow for higher-priority access to occur more quickly

Access to example object management platforms may be provided though an API, such as a ReST (Representational State Transfer) API. Object upload and object search and retrieval may be provided through such APIs. For example, ReST services may be hosted on an application server which may use its native authentication framework supported by an active directory (AD) component. This may enable coarse and fine grained security on stored objects. The platform may include security modules which interact with the AD and enable permissions to be set on objects, and to enable user authentication.

Example object management platforms may also include an object lifecycle management engine, which may include rules for determining when stored objects should be hot, warm, or cold. In some examples, this module may be present in a service controller, which may host rules for governing lifecycles for each object type.

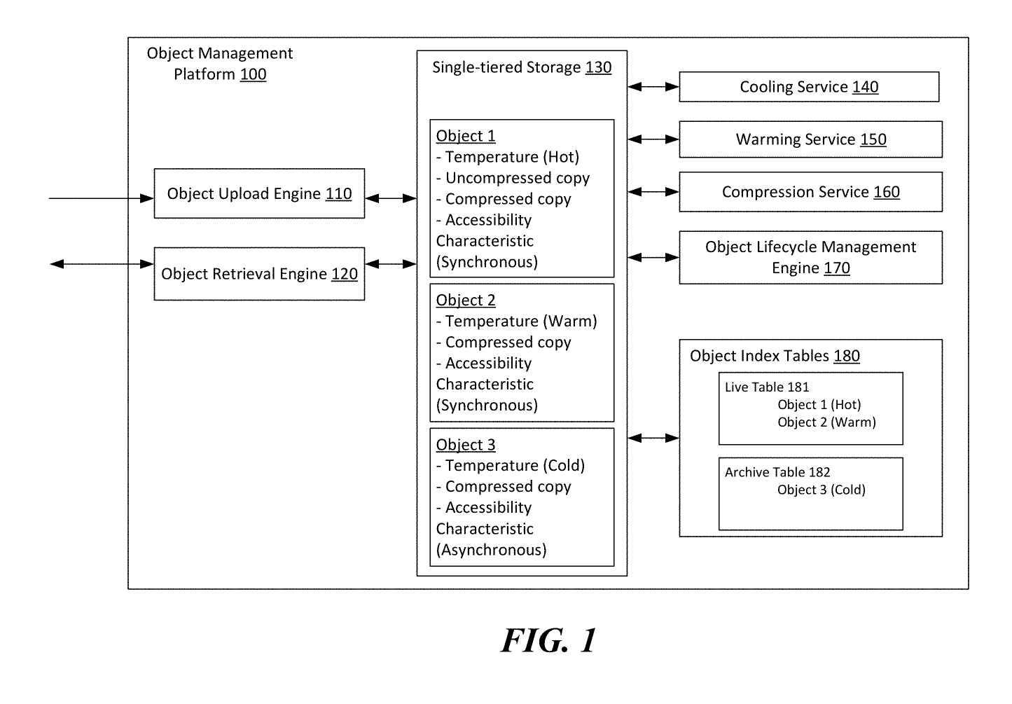

FIG. 1 illustrates an example object management platform, in which the described examples may be implemented. As shown in FIG. 1, an example object management platform 100 may include an object upload engine 110 to facilitate adding objects to be stored. Object management platform 100 may also include an object retrieval engine 120 to facilitate retrieval of stored objects. Object management platform may include single-tiered storage 130, which may include stored objects. For example, single-tiered storage 130 may contain a first object (object 1 in FIG. 1), which may have a hot temperature. As discussed above, an uncompressed copy of the object may be stored for hot objects, and a compressed copy of each object may be stored. An accessibility characteristic may be stored, indicating that access to the object should be synchronous access. Single-tiered storage 130 may also include a second object (object 2 in FIG. 1), which may have a warm temperature. As discussed above, only a compressed copy may be stored, and an accessibility characteristic may indicate that access to this compressed copy should be synchronous. Single tiered storage 130 may additionally include a third object (object 3 in FIG. 1), which may have a cold temperature. As discussed above, only a compressed copy may be stored, and an accessibility characteristic may indicate that access to this compressed copy should be asynchronous.

In addition to the object upload engine 110, retrieval engine 120, and single tiered storage 130, object management platform 100 may also include software services (e.g., instructions stored on a non-transitory machine readable medium executable by a processor) for lifecycle management of the stored objects. A cooling service 140 may provide for the transition of temperatures of objects from hot to warm, and from warm to cold, based on object's lifecycles. A warming service 150 may provide for the transition of temperatures of objects from cold to warm, and from warm to hot, based on object's lifecycles. A compression service 160 may provide for compression and decompression of uploaded and stored objects (e.g., compressing an object on upload, decompressing an object in connection with a transition to a hot temperature, or addition/extraction of an object to/from an MMC file). Finally, an object lifecycle management engine 170 may include rules for governing lifecycles for each object type. Object management engine 170 may also manage a schedule for cooling service 140 and warming service 150. Object management platform 100 may also include object index tables 180. The object index tables 180 may include a live table 181, which may include links (such as pointers) to hot and warm objects in single-tiered storage 130. Object index tables 180 may also include an archive table 182, which may store links to cold objects in single-tiered storage 130.

In some examples of FIG. 1, object upload engine 110 may process files to be stored in object management platform 100. For example, an object upload engine 110 may process volume input of files, and may accept content from client applications. Such content may be provided using drop zones for bulk uploads, via emails, etc. A typical upload flow may include the following steps:
1. Pick up object file and any associated metadata from the drop zone;
2. Determine object lifecycle (e.g., using object lifecycle management engine 170);
3. If the object is to start hot, store copy of object file in the object store, and update live table 181 by adding a link to the object file in single-tiered storage 130 (enabling the object for hot retrieval);
4. Compress object file and add to MMC file stored in object store (e.g., using compression service 160). If the object is to start warm, enable synchronous retrieval of object file and add link to the compressed copy of the object to live table 181. If the object is to start cold, enable asynchronous retrieval of object file and add link to the compressed copy of the object to archive table 182.

Further with respect to FIG. 1, object retrieval engine 120 may process object retrieval requests. For example, object retrieval engine 120 may receive a request for object 1, which is stored in single-tiered storage 130. As shown in FIG. 1, object 1 is hot, and consequently, an uncompressed copy of object 1 is stored in single-tiered storage 130. As discussed above, object retrieval engine 120 may respond to the request for object 1 by providing synchronous access to the uncompressed copy of object 1. In some examples, object retrieval engine may access a link to the uncompressed copy of object 1 in live table 181 to provide this access. Alternatively, object retrieval engine 120 may receive a request for object 2. Because object 2 is a warm object, only a compressed copy of object 2 is stored in single-tiered storage 130. As discussed above, object retrieval engine 120 may respond to the request for object 2 by providing synchronous access to the compressed copy of object 2. In some examples, object 2 may be part of an MMC, and object 2 may be extracted from the MMC and then provided in response to the request. In some examples, this extraction/decompression may be provided using compression service 160. In some examples, object retrieval engine 120 may locate the compressed copy of object 2 (e.g., the MMC file containing object 2) by accessing a link to object 2 in live table 181. Object retrieval engine 120 may also receive a request for object 3, a cold object. Object retrieval engine may respond to the request by providing asynchronous access to the compressed copy of object 3. For example, object retrieval engine may access a link to the compressed copy of object 3 in archive table 182 to access object 2 in single-tiered storage 130. As discussed above, an asynchronous request for a cold object may be made, and the requester does not wait for the object to be delivered, which may take several hours or even several days. Instead, for example, a requester may poll the object retrieval engine 120 to determine the status of the object request, and to receive the requested object when the request has completed.

While objects uploaded to object management platform 100 may be given an initial temperature, documents may change temperature (e.g., according to a lifecycle of the object type or due to how frequently the document is accessed). The object lifecycle management engine 170 may monitor the conditions under which an object's temperature is to change, and may signal cooling service 140 to decrease the temperature of an object (e.g., from hot to warm, or from warm to cold), or may signal warming service 150 to increase the temperature of an object (e.g., from cold to warm, and from warm to hot).

In accordance with example embodiments, when an object's temperature is to decrease from hot to warm, cooling service 140 may delete an uncompressed copy of the object from single-tiered storage 130. Cooling service 140 may also update links to the object in live table 181 to point to the compressed copy of the object rather than the now-deleted uncompressed copy. Object retrieval engine 120 may respond to subsequent requests for the now-warm object by providing synchronous access to the compressed copy of the object, as described above. When an object's temperature is to decrease from warm to cold, then cooling service 140 may update an accessibility characteristic of the object to indicate that access to the object should be asynchronous rather than synchronous. Cooling service 140 may also delete an entry in live table 181 for the object, and add an entry in archive table 182 for the object. Object retrieval engine 120 may respond to subsequent requests for the now-cold object by providing asynchronous access to the compressed copy of the object, as described above.

When an object's temperature is to increase from cold to warm, warming service 150 may update an accessibility characteristic of the object to indicate that access to the object should be synchronous rather than asynchronous. Warming service 150 may also delete an entry in archive table 182 for the object, and add an entry in live table 181 for the object. Object retrieval engine 120 may respond to subsequent requests for the now-warm object by providing synchronous access to the compressed copy of the object, as described above. When an object's temperature is to increase from warm to hot, warming service 150 may cause an uncompressed copy of the object to be stored in single-tiered storage (e.g., using compression service 160). Additionally, warming service 150 may update a link in live table 181 to point to this uncompressed copy. Object retrieval engine 120 may respond to subsequent requests for the now-hot object by providing synchronous access to the uncompressed copy of the object, as described above.

Note that while example warming operations have described warming objects from cold to warm, and from warm to hot, other example warming operations may warm objects from cold to hot (e.g., based on object lifecycle). Similarly, while example cooling operations have described cooling objects from hot to warm, and from warm to cold, other example cooling operations may cool objects from hot to cold (e.g., based on object lifecycle).

In some examples, cooling service 140 and warming service 150 may be scheduled to run at specific intervals to cool and warm objects according to object lifecycle information managed by object lifecycle management engine 170. Additionally, while not shown in FIG. 1 for simplicity, object management platform may also include a purge service, which may permanently delete objects when they are no longer needed (e.g., when a document retention plan calls for their deletion).

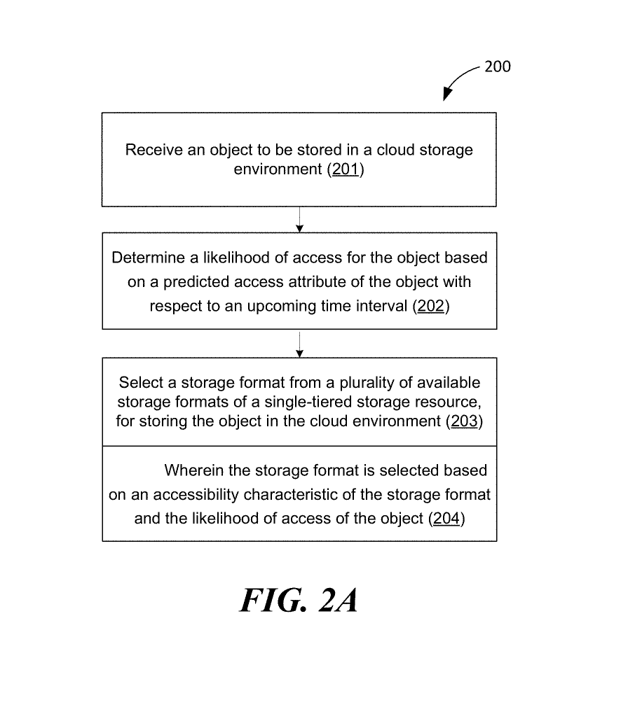

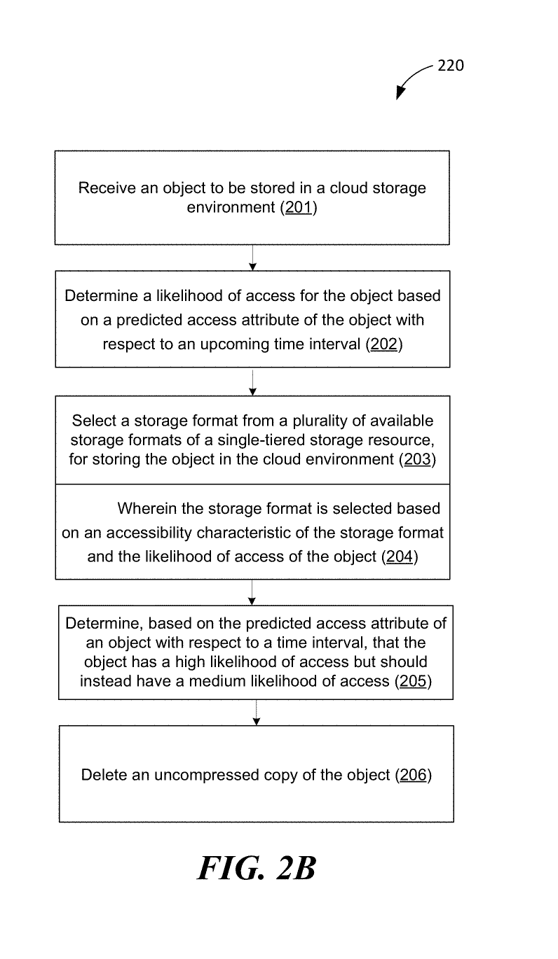

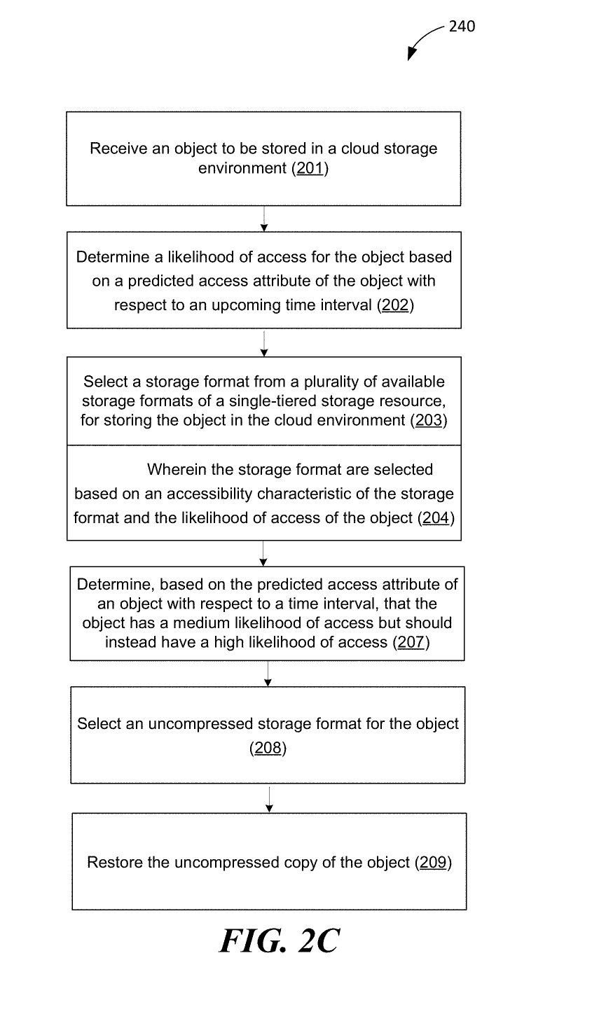

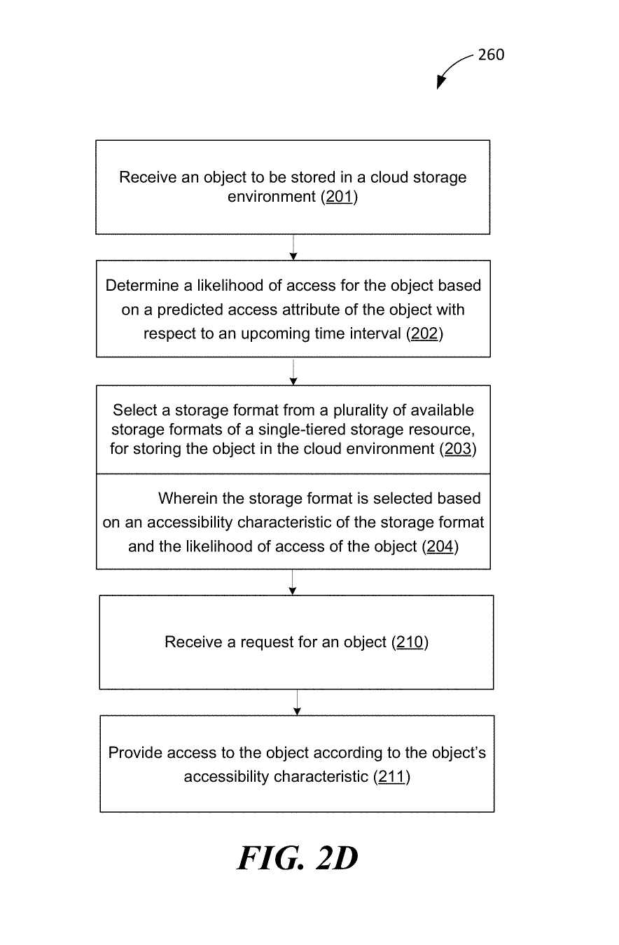

FIG. 2A illustrates an example method 200 for managing object storage in a cloud storage environment, according to the present examples. The method depicted in FIG. 2 may be performed, e.g., by object management platform 100 of FIG. 1.

In accordance with some examples, an object may be received for storage in a cloud storage environment (201). A likelihood of access may be determined for the object, based on a predicted access attribute of each with respect to an upcoming time interval (202). In some examples, the likelihood of access may be “high,” “medium,” or “low,” where high indicates that an object has a high likelihood of access, medium indicates that an object has a medium likelihood of access, and low indicates that an object has a low likelihood of access. In some examples, the likelihood of access may be determined by object lifecycle management engine 170 of object management platform 100 of FIG. 1. A storage format may be selected, from a plurality of available storage formats of a single-tiered storage resource, for storing the object in the cloud environment (203). The storage format may be selected based on an accessibility characteristic of the storage format and the likelihood of access of the object (204). In some examples, selecting the storage format may include selecting a compressed storage format for each object, and selecting an uncompressed storage format for each object having a high likelihood of access. After selecting the storage format, a copy of the object may be stored in the single-tiered storage resource, according to the selected storage format.

FIG. 2B illustrates another example method 220 for managing object storage in a cloud storage environment, according to some of the present examples. As shown in FIG. 2B, example method 220 may include the steps of example method 200 of FIG. 2A, and may also include determining, based on the predicted access attribute of an object with respect to the time interval, that the object has a high likelihood of access but should instead have a medium likelihood of access (205), and deleting an uncompressed copy of the object (206).

FIG. 2C illustrates another example method 240 for managing object storage in a cloud storage environment, according to some of the present examples. As shown in FIG. 2C, example method 240 may include the steps of example method 200 of FIG. 2A, and may also include determining, based on the predicted access attribute of an object with respect to the time interval, that the object has a medium likelihood of access but should instead have a high likelihood of access (207), selecting an uncompressed storage format for the object (208), and storing an uncompressed copy of the object (209).

FIG. 2D illustrates another example method 260 for managing object storage in a cloud storage environment, according to some of the present examples. As shown in FIG. 2D, example method 260 may include the steps of example method 200 of FIG. 2A, and may also include receiving a request for an object (210), and providing access to the object according to the object's accessibility characteristic (211).

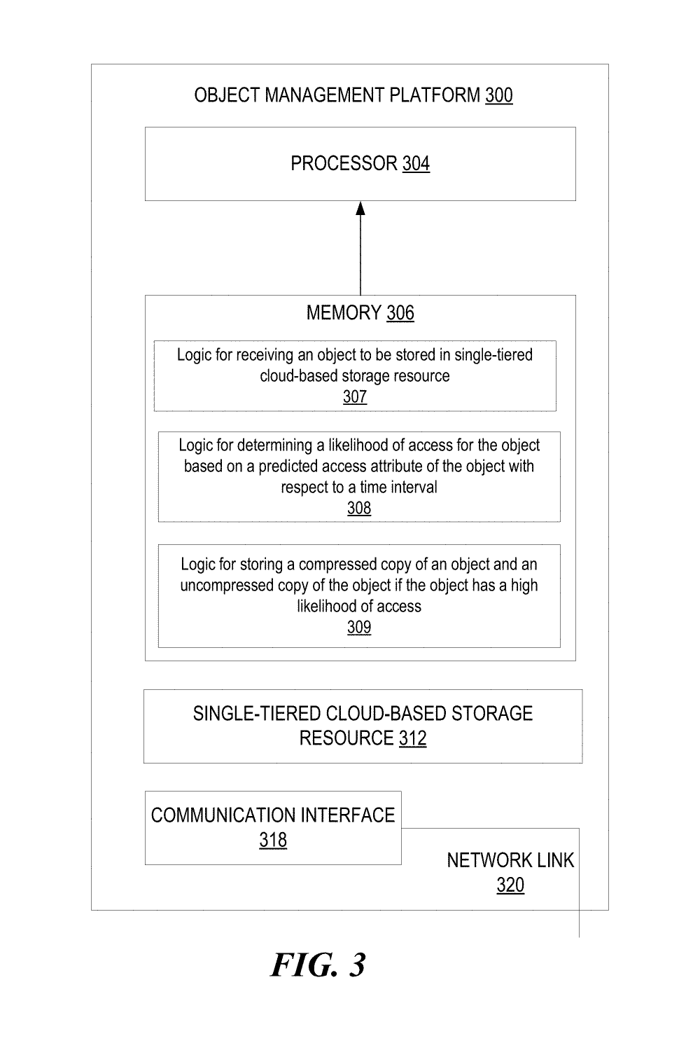

FIG. 3 is a block diagram that illustrates an object management platform according to embodiments described herein. For example, in the context of FIG. 1, object management platform 100 may be implemented using an object management platform such as described by FIG. 3.

In an embodiment, object management platform 300 includes processor 304, memory 306 (including non-transitory memory), single-tiered cloud-based storage resource 312, and communication interface 318. Object management platform 300 includes at least one processor 304 for processing information. Object management platform 300 also includes the memory 306, such as a random access memory (RAM) or other dynamic storage device, for storing information and instructions to be executed by processor 304. For example, memory 306 can store (i) logic for receiving an object to be stored in a single-tiered cloud-based storage resource 307, (ii) logic for determining a likelihood of access for the object based on a predicted access attribute of the object with respect to a time interval 308, and (iii) logic for storing a compressed copy of an object and an uncompressed copy of the object if the object has a high likelihood of access 309, in accordance with some aspects. In some examples, the method 200 of FIG. 2A, or the object management platform 100 of FIG. 1 may be implemented using the logic stored in memory 306. Memory 306 also may be used for storing temporary variables or other intermediate information during execution of instructions to be executed by processor 304. Object management platform 300 may also include a read only memory (ROM) or other static storage device for storing static information and instructions for processor 304. The single-tiered cloud-based storage resource 312, such as a magnetic disk or optical disk, is provided for storing information and instructions. The communication interface 318 may enable the object management platform 300 to communicate with a network (e.g., for receiving uploaded objects, or responding to object retrieval requests as in FIG. 1) through use of the network link 320 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., Wi-Fi and WiMAX networks).

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an embodiment, can be combined with other individually described features, or parts of other aspects. Thus, absence of describing combinations should not preclude the inventor(s) from claiming rights to such combinations.

What is claimed is:

1. A method for managing object storage in a cloud storage environment, the method comprising:
receiving an object to be stored in the cloud storage environment;
determining a likelihood of access for the object based on a predicted access attribute of the object with respect to a time interval; and
selecting a storage format from a plurality of available storage formats of a single-tiered storage resource, for storing the object in the cloud storage environment;
wherein the storage format is selected for the object based on an accessibility characteristic of the storage format and the likelihood of access of the object.

2. The method of claim 1, wherein the likelihood of access for the object is selected from the group consisting of (i) high, indicating that an object has a high likelihood of access, (ii) medium, indicating that an object has a medium likelihood of access, and (iii) low, indicating that an object has a low likelihood of access.

3. The method of claim 2, wherein selecting the storage format from the plurality of available storage format further comprises:
selecting an uncompressed storage format if the object has a high likelihood of access;
selecting a compressed storage format for the object; and
storing a copy of each individual object according to the selected storage format.

4. The method of claim 3, further comprising:
determining, based on the predicted access attribute of an object with respect to the time interval, that the object has a high likelihood of access but should instead have a medium likelihood of access; and
deleting the uncompressed copy of the object.

5. The method of claim 3, further comprising:
determining, based on the predicted access attribute of an object with respect to the time interval, that the object has a medium likelihood of access but should instead have a high likelihood of access;
selecting an uncompressed storage format for the object; and
restoring the uncompressed copy of the object.

6. The method of claim 3, further comprising:
receiving a request for an object; and
providing access to the requested object according to the object's accessibility characteristic.

7. The method of claim 6, wherein:
the requested object has a high likelihood of access; and
providing access to the requested object includes providing access to the uncompressed copy of the requested object according to a synchronous accessibility characteristic.

8. The method of claim 6, wherein:
the requested object has a medium likelihood of access; and
providing access to the requested object includes providing access to the compressed copy of the requested object according to a synchronous accessibility characteristic.

9. The method of claim 6, wherein:
the requested object has a low likelihood of access; and
providing access to the requested object includes providing access to the compressed copy of the requested object according to an asynchronous accessibility characteristic.

10. An object management platform, comprising:
a processor;
a single tiered cloud-based storage resource; and
a memory storing instructions that, when executed by the processor, cause the object management platform to:
receive an object to be stored in the single-tiered cloud-based storage resource;
determine a likelihood of access for the object based on a predicted access attribute of the object with respect to a time interval; and
if the object has a high likelihood of access, store a compressed copy of the object and an uncompressed copy of the object in the single-tiered cloud-based storage resource.

11. The object management platform of claim 10, wherein the likelihood of access for the object is selected from the group consisting of (i) high, indicating that an object has a high likelihood of access, (ii) medium, indicating that an object has a medium likelihood of access, and (iii) low, indicating that an object has a low likelihood of access.

12. The object management platform of claim 11, wherein execution of the instructions further causes the object management platform to:
if the object has a medium likelihood of access or a low likelihood of access, store a compressed copy of the object in the single-tiered cloud-based storage resource.

13. The object management platform of claim 12, wherein execution of the instructions further causes the object management platform to:
determine, based on the predicted access attribute of an object with respect to the time interval, that the object has a high likelihood of access but should instead have a medium likelihood of access; and
delete the uncompressed copy of the object.

14. The object management platform of claim 12, wherein execution of the instructions further causes the object management platform to:
determine, based on the predicted access attribute of an object with respect to the time interval, that the object has a medium likelihood of access but should instead have a high likelihood of access; and
store an uncompressed copy of the object in the single-tiered cloud-based storage resource.

15. A non-transitory computer-readable storage medium storing instructions that, when executed by a processor of an object management platform, cause the object management platform to:
receive an object to be stored in the cloud storage environment;
determine a likelihood of access for the object based on a predicted access attribute of the object with respect to a time interval; and
select a storage format from a plurality of available storage formats of a single-tiered storage resource, for storing the object in a cloud storage environment;
wherein the storage format is selected for the object based on an accessibility characteristic of the storage format and the likelihood of access of the object.
